(19) United States
(12) Patent Application Publication
(10) Pub. No.: US 2005/0058381 A1
(43) Pub. Date: Mar. 17, 2005

(54) Roller bearing

(76) Inventor: Manriyou Kiyo, Kanagawa (JP)

Correspondence Address: MILES & STOCKBRIDGE PC, 1751 PINNACLE DRIVE, SUITE 500, MCLEAN, VA, 22102-3833, US

(21) Appl. No.: 10/498,110

(22) PCT Filed: Dec. 27, 2002
(86) PCT No.: PCT/JP02/13810

(30) Foreign Application Priority Data
Dec. 28, 2001 (JP) 2001-399580

(51) Int. Cl. F16C 33/34

(52) U.S. Cl. 384/565

(57) ABSTRACT

The anti-seizure property of the contact sections between the inside surfaces 11a, 11a of the outward-facing and inward facing flange sections 8a, 10a, and the axial end surfaces of the rollers 5a is improved, and the axial load capacity at the sections is improved.

A roller bearing is provided to have rollers 5a which have axially opposite ends in contact with the inner side surfaces 11a, 11a of an outward-facing and inward-facing flange sections 8a, 10a and in a tapered convex surface 22, 22 such that the outer diameter of the tapered convex surface 22, 22 becomes larger toward the middle of the rollers 5a, and that the line normal to the generatrix at the centers S, S of the convex surface 22, 22 passes through the center O of the rollers 5a. As a reluts, no moment to make the roller 5a tilt occurs with the force applied to the contact sections between the tapered convex surface of the rollers 5a and the inside surfaces 11a, 11a of the flange sections 8a, 10a.

### TECHNICAL FIELD OF THE INVENTION

The roller bearing of this invention is used for supporting a rotating shaft, such as a rotating shaft used in industrial equipment such as a rolling mill, or the rotating shaft of a gear transmission used in railroad cars, construction equipment or the like, to which not only radial loads but also axial loads are applied during operation; such that it supports the rotating shaft so as to rotate freely with respect to a stationary section such as a housing. More particularly, this invention relates to a roller bearing that is capable of sufficiently maintaining its seizure resistance even when heavy loads, vibration, impact, fluctuating loads and the like are applied during rotating at high speed.

### BACKGROUND TECHNOLOGY OF THE INVENTION

Axial loads, in addition to radial loads, are applied to the support shaft that is fastened to the end of the roll of a rolling mill, or to the rotating shaft that is fastened to the helical gear of a gear transmission for driving a railroad car. Therefore, the rolling bearing for supporting these rotating shafts such that they can rotate freely with respect to the housing must be able to support radial loads as well as axial loads. In order to accomplish that, conventionally it has been common to support the rotating shaft with respect to the housing using at least one pair of tapered roller bearings that have different contact angles, or using an angular ball bearing, deep-groove ball bearing, or 3-point or 4-point contact ball bearing, or using a cylindrical roller bearing together with the bearing as mentioned above.

However, in the case of supporting the rotating shaft with an angular ball bearing, deep-groove ball bearing, or 3-point or 4-point contact ball bearing, the radial load that can be supported is less than the radial load that can be supported with tapered roller bearings. Therefore, in order to support large radial loads, it is necessary to combine these bearings with a cylindrical roller bearing as mentioned above. However this results in an unavoidable increase in the dimensions of the rotation-support section. On the other hand, in the case of supporting the rotating shaft with the tapered roller bearings, adjusting the clearance in the tapered roller bearing is very troublesome. Particularly, the temperature of the housing section greatly changes due to seasonal changes and furthermore due to the effects of heat generated by surrounding equipment. In order to prevent the tapered rollers from seizing up or causing backlash regardless of there being this kind of large temperature change, the internal clearance of the tapered roller bearings must be very precisely adjusted, which is troublesome.

Moreover, in addition to the fact that the radial load that can be supported by these tapered roller bearings is less than the radial load that can be supported by a cylindrical roller bearing, it is also impossible to avoid large slippage that occurs at the area of contact between the surface on the large-diameter end of the tapered roller and the surface of the flange section that fits around this surface. Large slippage at this area of contact increases the friction on each surface and makes it easier for damage such as slippage marks or smearing, or in extreme cases, damage due to scraping or seizure to occur. Also, the wear on each surface due to this slippage increases the internal clearance, so in the case of tapered roller bearings used in the drive mechanism for a railroad car for example, it is necessary to periodically adjust this clearance, and this adjustment of the internal clearance also is troublesome. On the other hand, in the case of an N-type or NU-type cylindrical roller bearing, the radial load that they can support is greater than the radial load that can be supported by the tapered roller bearings, however, it is not possible to support loads in the axial direction only with the cylindrical roller bearing.

Therefore, this kind of cylindrical bearing must be used together with the tapered roller bearings or ball bearings, and thus it is impossible to avoid an increase in the dimensions of the rotation-support section.

Conventionally, in order to solve these problems, the use of a cylindrical roller bearing having a race with a flange section, as shown in FIG. 13, as the rolling bearing for supporting the rotating shaft in the housing, was proposed. For example, it is conventionally known in the art as in Patent Literatures 1 to 3, and non-patent Literatures 1 and 2. In the case of a N-type or NU-type cylindrical roller bearing described above, it is not possible to support axial loads, even though radial loads can be supported, however, the roller bearing 1 shown in FIG. 13 is able to support axial loads because of the engagement between the end surfaces in the axial direction of the rolling elements or cylindrical rollers 5, and the inner surfaces 11, 11 of the flange sections 8, 10 formed around the circumference of the inner race 2 and outer race 3, respectively.

In other words, this roller bearing 1 comprises an inner race 2, outer race 3, flanged ring 4, a plurality of cylindrical rollers 5 and a cage 6. Of these, the inner race 2 has a cylindrical-shaped inner-ring raceway 7 formed around the middle of its outer peripheral surface, and outward facing flange sections 8, 8 formed on the opposite ends thererof. Also, the outer race 3 has a cylindrical shaped outer-ring raceway 9 formed around its inner peripheral surface except for one end in the axial direction (right end in FIG. 13) thereof, and there is an inward facing flange section 10 on the one end. In addition, the flanged ring 4 is located such that it comes in contact with the other end in the axial direction (left end in FIG. 13) of the outer race 3, and has an inner-diameter section that protrudes further inward in the radial direction than the outer-ring raceway 9 to function as the inward facing flange section 10. Moreover, the cylindrical rollers 5 are rotatably held in the cage 6 between the inner-ring raceway 7 and outer-ring raceway 9.

With this roller bearing 1, constructed as described above, the end surfaces on the axially opposite sides of the cylindrical rollers 5 face the pair of outward facing flange sections 8, 8 on the radially inner side and the pair of inward facing flange sections 10, 10 on the radially outer side, and thus the roller bearing supports axial loads in the opposite directions by cooperation between the cylindrical rollers 5 and the flange sections 8, 10. In other words, by supporting the rotating shaft with the roller bearing 1 constructed as described above, such that it rotates freely with respect to the housing, it is possible by the housing via the roller bearing 1 to support the axial loads applied to the rotating shaft. By using this kind of roller bearing 1, in addition to being able to support larger radial loads than the tapered roller bearings, the work of adjusting the internal clearance during assembly between the rotating shaft and housing is simplified.

The following are prior art technology with respect to the present invention:

Patent Literature 1: Tokukai Hei 8-93756

Patent Literature 2: Tokukai Hei 9-88970

Patent Literature 3: Tokukai 2001-151103

Non-patent Literature 1: “NSK Rolling Bearing Brochure” No. 140c, 1995, page B81 published by NSK.

Non-patent Literature 2: “Rolling Bearing Brochure” No. 2202-II/J. 1997.9. page B-92 published by NTN.

In the case of supporting axial loads with the roller bearing 1 described above, the axial loads are only supported by the contact area (sliding contact area) between the opposite end surfaces of the cylindrical rollers 5 and either the outward facing flange sections 8 or inward facing flange sections 10. Therefore, at this area of contact, there is high-speed sliding contact when supporting large axial loads, and the PV value, which is the product of the contact pressure (P) and sliding velocity (V), becomes large. Especially in the case of supporting large axial loads, or in the case when the axial load is a vibrating load or impact load, or when operating under severe lubrication conditions (for example, minute amount of lubrication), there is a possibility of scraping or seizure occurring at the area of contact.

Moreover, when axial loads are applied to the roller bearing 1, a force or so called “tilt moment” is applied to the cylindrical rollers 5 due to the axial load that causes the axis of rotation of the cylindrical rollers 5 to tilt. In other words, when an axial load Fa is applied as shown in FIG. 13, the forces shown in the same figure by the arrows α, α are applied in opposite directions on the axially opposite ends of the cylindrical rollers 5 and on the radially opposite sides of cylindrical rollers 5. Also, these opposing forces become a moment force (tilt moment), as shown by arrow β in FIG. 13, that is applied to the cylindrical rollers 5 to tilt the axis of rotation of the cylindrical rollers 5. Of course, when an axial load is applied in the opposite direction of the axial load Fa shown in FIG. 13, a tilt moment in the direction opposite the arrow β (counterclockwise direction) is applied to the cylindrical rollers 5. This tilt moment tilts the cylindrical rollers 5, making it easy for the outer peripheral edge on the end surfaces of the cylindrical rollers 5 to come in contact with the inner surfaces 11, 11 of the upward or outward facing flange sections 8, 10, or the inner-ring raceway 7 and outer-ring raceway 9. As a result, edge loading occurs on the inner surfaces 11, 11 of these flange sections 8, 10 and both of the raceways 7, 9, so that the durability of these portions is reduced.

In the case of the structure with a cage, there are also problems as follows; Specifically, the shape of the outer peripheral portion of the opposite ends in the axial direction of the respective cylindrical rollers 5 is relatively sharp-pointed (formed substantially at right angles), and the shape of the pockets 12, 12 in the cage 6 for holding the respective cylindrical rollers 5 has an angular corner as shown in FIG. 14. Because of this, when the rolling contact surface of the respective cylindrical rollers come into contact with the inside surface of the respective pockets 12, 12, the stress applied to the corner portion becomes easily large, and it may be difficult to secure the durability of the cage 6.

An object of the roller bearing of this invention is to solve the problems mentioned above.

### DISCLOSURE OF THE INVENTION

The roller bearing of this invention comprises: an inner race having a cylindrical inner-ring raceway around its outer peripheral surface, an outer race having a cylindrical outer-ring raceway around its inner peripheral surface, and a plurality of rollers located between the outer-ring raceway and inner-ring raceway that can rotate freely; and flange sections, wherein of both ends in the axial direction of the outer-ring raceway and inner-ring raceway, the flange sections are formed at least on the axially opposite ends with respect to the outer ring raceway and inner ring raceway, respectively. Axial loads on the roller bearing are supported by the engagement between the side surfaces of the flange sections and the end surfaces in the axial direction of the rollers. Particularly, in the case of the roller bearing of this invention, the outer peripheral surfaces of the rollers are cylindrical in shape, and the sections of the opposite ends in the axial direction of the rollers near the outer diameter coming into contact with the side surfaces of the flanged sections are formed in a tapered convex surface tilted in a direction such that the outer diameter is increased towards the axial center of the rollers. In addition, the portion of the side surface of the flanged section coming into contact with the tapered convex surface is formed in a tapered convex surface or tapered concave surface having a generatrix with the same tilting angle to the generatrix of the tapered convex surface. In addition, of the tapered convex surfaces in the opposite ends of the rollers, the line connecting any point on the generatrix of the portion coming in contact with the tapered convex surface or tapered concave surface of the flanged section with the center of the rollers coincides with the line normal to the generatrix at this point.

Incidentally, the point on the generatrix of the contact sections exist in the middle portion of the ganeratrix at this portion. This middle portion is between the opposite ends of the generatrix of the portion and not limited to the central portion of the generatrix at this portion. (Of course, the central portion is included, and the portions adjacent to the both ends are included.) What is important is that the line normal to the middle portion at any point passes through the center of the rollers. In other words, it is enough that the line vertical to the generatrix at the contact sections can be drawn from this center.

The generatrix of the contact sections means an overlapping section between the generatrix of the tapered convex surface existing on the opposite ends of the rollers and the generatrix of the tapered convex surface or tapered concave surface of the flanged sections coming into contact with each other.

In the case of the roller bearing of this invention, the condition of contact between the end surfaces in the axial direction of the rollers and the side surfaces of the flange sections can be taken to be linear contact, so that a condition near the rolling contact (condition where the rolling component is larger than the sliding component) is achieved. Therefore, even when rotating at high speed, it is difficult for damage such as slide marks, smearing, scraping, seizure and the like to occur, and even in the case of impact loads, vibrating loads, or repeated loads, its seizure resistance can be maintained.

Moreover, at the area of contact between the tapered convex surfaces of the rollers and the tapered convex surfaces or tapered concave surfaces of the flange sections, the force due to axial loading and radial loading is applied in the direction normal to this area of contact. In addition, the forces applied in the direction normal to these areas of contact act toward the center of the rollers and cancel each other out. In other words, of the tapered convex surfaces on both ends of the rollers, a line is provided for connecting any point on the genetatrix in contact sections that come into contact with the tapered convex or concave surfaces of the flange sections with the center of the rollers, and this line coincides with the line normal to the generatrix at that contact section, so that the forces due to the axial load and radial load act toward the center of the rollers and cancel each other out. Therefore, it becomes difficult for a force to act that will cause the rollers to displace.

For example, it is also possible to greatly reduce (almost to zero) the tilt moment applied to the rollers, and it becomes difficult for the axis of rotation of the rollers to come out of alignment with the axis of rotation for the inner race and outer race, and thus it becomes difficult for edge loading to occur on the side surfaces of the flange sections and on the inner-ring raceway and outer-ring raceway. As a result, the bearing performance for axial load performance at the area of contact can be improved (no damage such as scraping or seizure occurs at the area of contact, while it becomes possible to support greater axial loads), and since the roller bearing does not need to be used in combination with other rolling bearings, it also becomes possible to lower costs of the bearing by making it more compact and simplified.

### BRIEF DESCRIPTION OF THE DRAWINGS

FIG. 1 is a cross sectional view of a half of a first example of the embodiment of the Invention.

FIG. 2 is an enlarged view of a roller.

FIG. 3 is an enlarged cross sectional view of part of an inner ring.

FIG. 4 is a plan view of part of a retainer.

FIG. 5 is a cross sectional view of part of a second example of the embodiment of the present invention.

FIG. 6 is a cross sectional view of part of a third example of the embodiment of the present invention.

FIG. 7 is a cross sectional view of part of a fourth example of the embodiment of the present invention.

FIG. 8 is cross sectional view of part of a fifth example of the embodiment of the present invention.

FIG. 9 is a cross sectional view of part of a sixth example of the embodiment of the present invention.

FIG. 10 is a cross sectional view of part of a seventh example of the embodiment of the present invention.

FIG. 11 is a cross sectional view of a half of an eighth example of the embodiment of the present invention.

FIG. 12 is a cross sectional view of a half of a ninth example of the embodiment of the present invention.

FIG. 13 is a cross sectional view of part of an example of the conventional structure of the roller bearing.

FIG. 14 is a plan view of part of a retainer.

### DESCRIPTION OF THE BEST EMBODIMENT TO WORK THE INVENTION

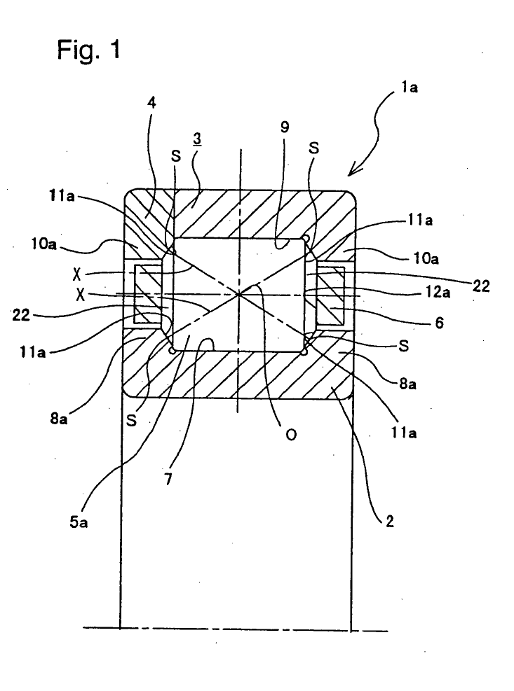

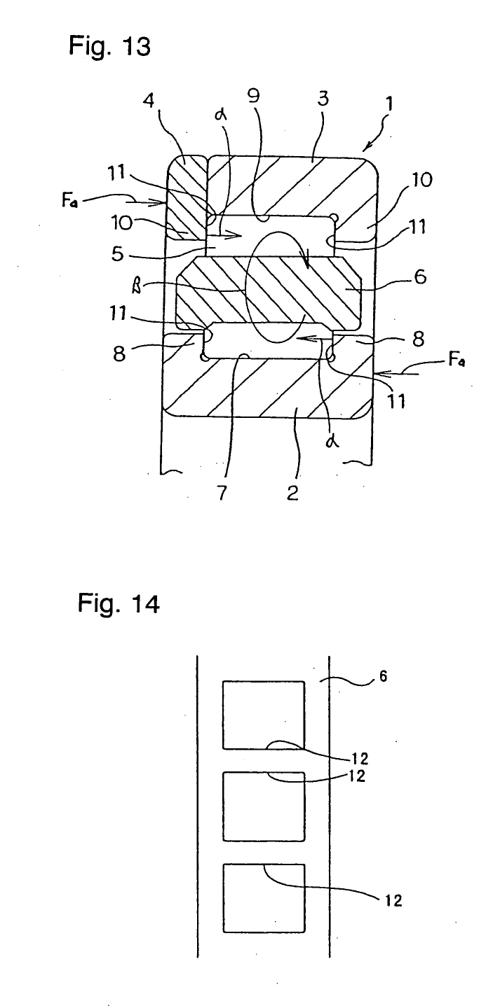

FIGS. 1 to 4 show a first example of the embodiment of the invention. This example is characterized in that both of the end surfaces in the axial direction of the rollers 5a and the inner surface 11a, 11a of the outward and inward facing flange sections 8a, 10a are tailored in shape. The construction and function of all other parts are substantially the same as those of the roller bearing 1 that is shown in FIG. 13 and described above, and the same symbols are given to like parts, and any redundant explanation is simplified and only the main parts of this example will be explained here.

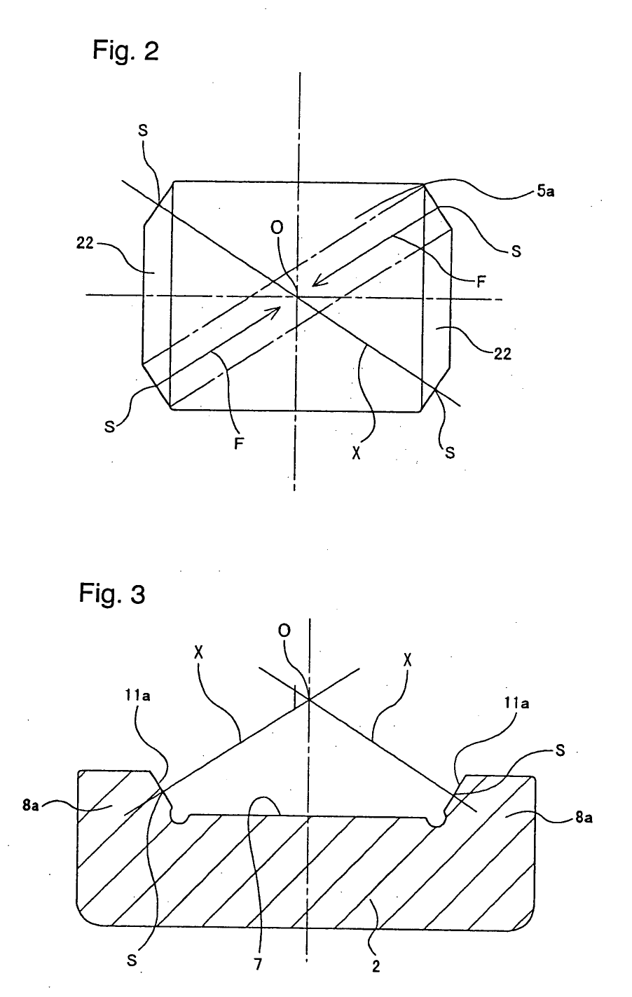

In the case of the roller bearing la of this example, the surfaces on the axially opposite ends of the rollers 5a have a section that fits with the inner surfaces 11a, 11a that are formed on the outward-facing and inward-facing flange sections 8a, 10a of the inner race 2, outer race 3 and flanged ring 4. These sections of the rollers 5 are shaped as shown in FIG. 2 such that they are tapered convex surfaces 22, 22 inclined such that the outer diameter increases in the direction toward the middle in the axial direction of the roller 5a. This kind of tapered convex surface 22, 22 can be manufactured at lower cost than when the surface of this section is a spherical convex surface. On the other hand, of the inner surfaces 11a, 11a of the outward-facing flange sections 8a, 8a, at least sections that come into contact with the tapered convex surfaces 22, 22 of the rollers 5a, are tapered convex surfaces having a generatrix with the same angle of inclination as the generatrix of the tapered convex surfaces 22, 22 as shown in FIG. 3. FIG. 3 shows only the inner race 2, however, as shown in FIG. 1, of the inner side surfaces 11a, 11a of the inward-facing flange section 10a, 10a of the outer race 3 and the flanged ring 4, at least contact sections that fit with the tapered convex surfaces 22, 22 of the rollers 5a, are tapered concave surfaces having a generatrix with an angle of inclination that is the same as that of the generatrix of the tapered convex surfaces 22, 22, in substantially the same way as for the outward-facing flange sections 8a, 8a of the inner race 2.

Furthermore, in the case of this example, as shown in FIG. 2, of the tapered convex surfaces 22, 22 on both ends of the roller 5, contact sections come in contact with the tapered convex or concave surfaces of the outward-facing and inward-facing flange sections 8a, 10a, and the connecting line ‘X’ that connects the centers S, S of the generatrix of the contact sections with the center O of the roller 5 coincides with the line normal to the generatrix of this centers S, S. Also, together with this, as shown in FIG. 1 and FIG. 3, of the tapered convex surfaces or tapered concave surfaces of the outward-facing and inward facing flange sections 8a, 10a, at the sections which come into contact with the tapered convex surfaces 22, 22 on both ends of the roller 5a, the connecting line ‘X’ that connects the center O of the roller 5a with the center S, S of the generatrix of the corresponding side surface sections also coincides with the line normal to the generatrix of at the centers S, S. Therefore, the force applied to the areas of contact between the tapered convex sections 22, 22 of the roller 5a and the tapered convex surface or tapered concave surface of the outward-facing and inward-facing flange sections 8a, 10a due to axial loads and radial loads is applied toward the center O of the roller 5a as shown by arrow F in FIG. 2.

In the case of the roller bearing la of this example, the tapered convex surfaces 22, 22 are formed on the end surfaces on the axially opposite sides of the rollers 5a, and of the inner side surfaces 11a, 11a of the outward-facing and inward-facing flange sections 8a, 10a, contact sections come into contact with the end surfaces of the rollers 5a such that the contact sections are tapered convex surfaces or tapered concave surfaces having generatrix with the same angle of inclination as the generatrix of tapered convex surfaces 22, 22. Therefore, the condition of contact between these surfaces can be taken to be linear contact, so that a condition near the rolling contact (the rolling component is larger than the sliding component) is obtained. As a result, sliding at the area of contact between these surfaces is reduced even at high rpm, and thus it is possible to reduce damage such as sliding marks, smearing, scraping, seizure and the like, and it is possible to maintain seizure resistance even when impact loads vibrating loads or repeated loads are applied.

At the contact sections between the tapered convex surfaces 22, 22 of the rollers 5a and the tapered convex surfaces or tapered concave surfaces of the outward-facing and inward-facing flange sections 8a, 10a, the forces due to axial loads and radial loads are applied in the direction normal to the generatrix of each surface at these areas of contact. Also, the forces applied in the direction normal to these areas of contact act in the direction toward the center O of the roller 5a, and cancel each other out, respectively. In other words, of the tapered convex surfaces 22, 22 on both ends of the roller 5a, since the line X connecting the center O of the roller 5a with the centers S, S of the generatrix of the contact sections in contact with the tapered convex surfaces or tapered concave surfaces of the outward-facing and inward-facing flange sections 8a, 10a, coincides with the line normal to the generatrix of these center points S, S, the forces F due to axial loading and radial loading (see FIG. 2) act in a direction toward the center of the roller 5, and cancel each other out.

Therefore, it becomes difficult for forces that would displace the rollers 5a to occur. For example, it is also possible to greatly reduce (to nearly 0) the tilt moment applied to the rollers 5a as well, and it becomes difficult for the axis of rotation of the rollers 5a to come out of alignment with the center axis of the inner race 2 and outer race 3, and thus it also becomes difficult for edge loading to occur on the inner side surfaces 11a, 11a of the outward-facing and inward-facing flange sections 8a, 10a and on the inner-ring raceway 7 and outer-ring raceway 9. As a result, it is possible to improve the axial load capability at the areas of contact (capability to support large axial loads without damage such as scraping and seizure occurring at the areas of contact), and since it is not necessary to use the roller bearing in combination with other rolling bearings, it is possible to simplify and make the rotation support section more compact, and thus further reduce the cost by making the roller bearing more compact and simple.

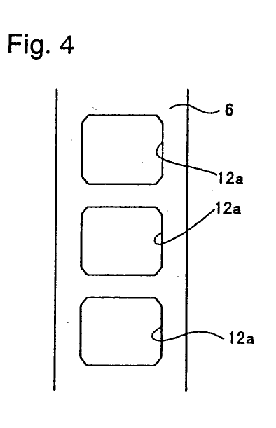

Since the shape of the outer periphery at the opposite ends in the axial direction of the rollers 5a is relatively smooth due to the existence of the tapered convex surfaces 22, 22, the shape of the pockets 12a, 12a in the cage 6 for holding the rollers 5a can be made relatively smooth at the comers as shown in FIG. 4. Therefore, when the rolling contact surface of the rollers 5a comes into contact with the inside surface of the pockets 12a, 12a, the stress applied to the corners can be kept low, and so the durability of the cage 6 can be secured.

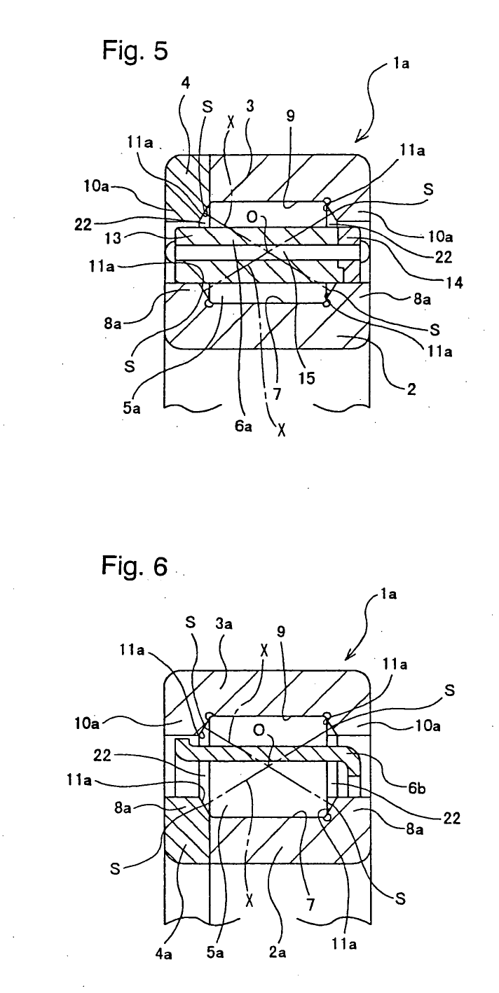

Next, FIG. 5 shows a second example of the embodiment of the invention. In the case of this example, the cage 6a, which holds the rollers 5a such that they rotate freely, is a so-called “rivet-fixed, machined cage”. In other words, in the case of the first example shown in FIG. 1, the cage is a machined cage 6 that is a single member made out of synthetic resin or metal and formed in a generally cylindrical shape with a plurality of pockets 12 formed at equal intervals around the circumference in the axially middle section. On the other hand, the cage 6a assembled in this example is made out of synthetic resin or metal and formed generally into a comb-type ring shape, and comprises a main member 13, which has a plurality of pockets formed at equal intervals around the circumference such that each pocket has one end (right end) open on the one axial end surface (right end surface) of the main member 13, and a circular ring member 14, which is also made out of synthetic resin or metal, that covers the open end of the pockets. Also, rivets 15 are located in the column sections of the main member 13 between the pockets 12 such that they penetrate through the column sections and the circular ring member 14 in the axial direction, and connect the main member 13 with the circular ring member 14, so that they cannot be separated. The other construction and function of this embodiment, including the shape of the rollers 5a and outward-facing flange sections 8a and inward-facing flange sections 10a, are substantially the same as those of the first example described above.

Next, FIG. 6 shows a third example of the embodiment of the present invention. While, in the first example shown in FIG. 1 and the second example shown in FIG. 5, the invention is applied to a NP-type roller bearing 1 in which a flanged ring 4 is located on one end (left end) in the axial direction of the outer race 3, in this example, the invention is applied to a NUP-type roller bearing la in which a flanged ring 4a is located on one end (left end) in the axial direction of the inner race 2a. In the case of this example as well, the sections on both end surfaces in the axial direction of the rollers 5a that fit with the inner side surfaces 11a, 11a of the outward-facing and inward-facing flange sections 8a, 10a have tapered convex surfaces 22, 22 that are inclined in the direction such that the inner diameter becomes larger in the direction toward the middle in the axial direction of the roller 5a.

And, in addition, of the tapered convex surfaces 22, 22, the line X for connecting the center points S of the generatrix of the contact sections with the tapered convex surface of the outward flange section 8a, the center point S of the generatrix of the contact sections with the tapered concave section of the inward facing flange portion 10a with the center O of the roller 5a coincides with the line normal to the respective generatrix.

On the other hand, the sections of the inner side surfaces 11a, 11a of the outward-facing and inward-facing flange sections 8a, 10a coming into contact with the tapered convex surfaces 22, 22 of the rollers 5a are tapered convex surfaces (in the case of the inner side surface 11a of the outward-facing flange section 8a) or tapered concave surfaces (in the case of the inner side surface 11a of the inward-facing flange section 10a) whose generatrix has an angle of inclination that is the same as those of the tapered convex surfaces 22, 22. Furthermore, in the case of this example, the cage 6b, which holds the rollers 5a such that they can rotate freely, is a so-called “pressed cage” that is made by pressing a metal plate. This cage 6b is formed such that one end (left end) in the axial direction bends outward in the radial direction, and similarly, the other end (right end) bends inward in the radial direction. The other construction and function are substantially the same as that of the first example described above.

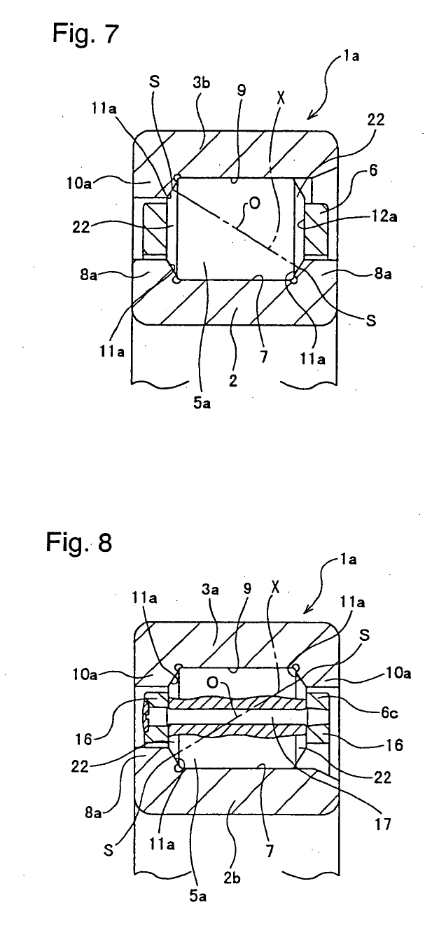

Next, FIG. 7 shows a fourth example of the invention. While in the case of the first and second examples shown in FIGS. 1 and 5, the invention is applied to a NP-type roller bearing la in which a flanged ring 4 is located on one end in the axial direction (left end) of the outer race 3, in the case of this example, the invention is applied to a NF-type roller bearing la in which the flanged ring 4 is omitted, and the inward facing flange section 10a is formed only on one (left end) of the opposite ends of the outer race 3b. In this example, axial loads are supported in only one direction. In other words, axial loads applied on one side surface (left side surface) of the outer race 3b from one side (left side) to the other (right side) are supported, and axial loads applied on the other side surface (right side surface) of the inner race 2 from the other side (right side) to the one side (left side) are supported. In the case of supporting axial loads in only one direction in this way, there is no axial load applied between the inner side surface 11a of one (left one) of the outward-facing flange sections 8a, 8a formed on both ends of the inner race 2 and one end surface (left end surface) in the axial direction of the roller 5a. Therefore, the inner side surface 11a of that one outward-facing flange section 8a does not necessarily need to be a tapered convex surface, however, in the case of this example, in order to do away with any special assembly direction of the inner race 2, both inner side surfaces 11a, 11a of the outward facing flange sections 8a, 8a are tapered convex surfaces. The other construction and function, including the shape of the rollers 5a, and outward-facing and inward-facing flange sections 8a, 10a are substantially the same as those of the first example described above.

Next, FIG. 8 shows a fifth example of the embodiment of the invention. While in the case of the fourth example shown in FIG. 7, the invention is applied to a NF-type roller bearing la in which an inward-facing flange section 10a was formed on only one end (left end) of the two ends of the outer race 3b, in the case of this example, the invention is applied to a NJ-type roller bearing la in which the outward-facing flange section 8a is formed on only one end (left end) of the two ends in the axial direction of the inner race 2. In the case of this example as well, axial forces only in one direction are supported as explained in FIG. 7, and the sections on both ends in the axial direction of the rollers 5a that come into contact with the inner side surfaces 11a, 11a of the outward-facing and inward-facing flange sections 8a, 10a are tapered convex surfaces 22, 22 that are inclined in a direction such that the outer radius becomes larger in the direction toward the middle in the axial direction of the roller 5a. Also, together with this, of the tapered convex surfaces 22, 22 on both ends of the roller 5a, the line ‘X’ connecting with the center O of the roller 5a with the centers S, S of the generatrix of the contact sections that come in contact with the tapered convex or tapered concave surfaces of the outward-facing and inward-facing flange sections 8a, 10a coincides with the line normal to the generatrix of the centers S, S.

On the other hand, the contact sections of the inner side surfaces 11a, 11a of the outward-facing and inward-facing flange sections 8a, 10a that fit with tapered convex surfaces 22, 22 of the rollers 5a are tapered convex surfaces or tapered concave surfaces having a generatrix with the same angle of inclination as the generatrix of the tapered convex surfaces 22, 22. Furthermore, in the case of this example, the cage 6c, which holds the rollers 5a such that they can rotate freely, is a so-called “pin-type cage” that comprises a pair of elements 16, 16 formed in a ring shape and which are connected by a connecting pin 17 that passes through the center axis of the rollers 5a such that they cannot be separated. The other construction and function are substantially the same as those of the fourth example described above.

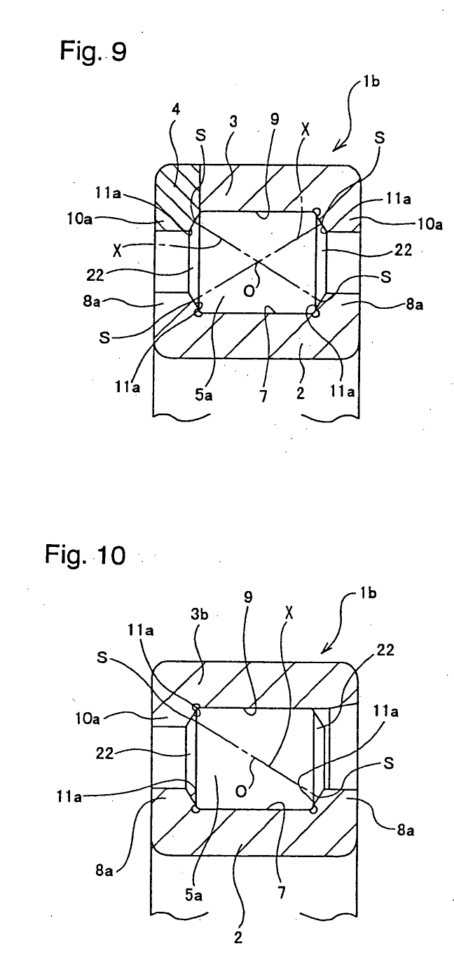

Next, FIG. 9 shows a sixth example of the embodiment of the invention. While in the case of examples 1 to 5 shown in FIGS. 1 to 8, the invention is applied to a roller bearing la having the cage 6, 6a, 6b, 6c, in the case of this example, the invention is applied to a full complement roller bearing (full complement rolling bearing) 1b that has no cage. In the case of this example, it is possible to increase the number of rollers 5a in the place of the cage that is not used. Therefore, it is possible to support more load without having to increase the size of the roller bearing 1b. Of course, in this example as well, the sections of the surfaces on both ends in the axial direction of the rollers 5a that fit with the inner side surfaces 11a, 11a of the outward-facing and inward-facing flange sections 8a, 10a are tapered convex surfaces 22, 22 that are inclined in a direction such that the outer radius becomes larger in the direction toward the middle in the axial direction of the roller 5a. Also, together with this, the line X′ connecting the centers S, S of the generatrix of the sections of the tapered convex surfaces 22, 22 on both ends of the roller 5a that comes in contact with the tapered convex or tapered concave surfaces of the outward-facing and inward-facing flange sections 8a, 10a with the center O of the roller 5a coincides with the line normal to the generatrix of the center S, S. On the other hand, the sections of the inner side surfaces 11a, 11a of the outward-facing and inward-facing flange sections 8a, 10a that fit with tapered convex surfaces 22, 22 of the rollers 5a are tapered convex surfaces or tapered concave surfaces having a generatrix with the same angle of inclination as the generatrix of the tapered convex surfaces 22, 22. The other construction and function are the same as those of the first example.

Next, FIG. 10 shows a seventh example of the embodiment of the invention. Similar to the sixth example shown in FIG. 9, the invention in this example is applied to a full complement roller bearing 1b that has no cage. Also, in the case of this example, similar to the fourth example shown in FIG. 7, the roller bearing 1b is a NF-type full complement roller bearing in which an inward-facing flange section 10a is only located on one end (left end) of the outer race 3b with the flanged ring 4 omitted. The other function and construction, including the shape of the roller 5 and outward-facing and inward-facing flange sections 8a, 10a are substantially the same as those of the fourth and sixth examples described above.

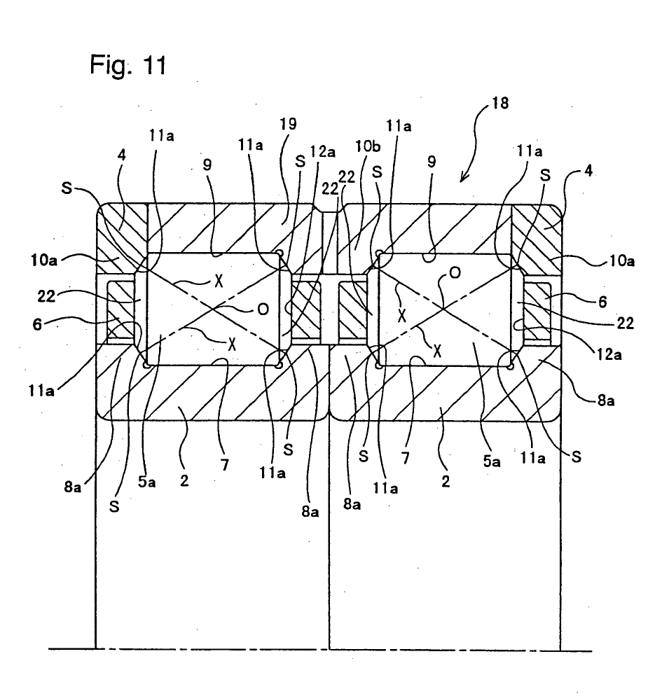

Next, FIG. 11 shows an eighth example of the embodiment of the invention. While in the case of the first to seventh examples shown in FIGS. 1 to 10, the invention is applied to a single-row roller bearing 1a, 1b, in the case of this example, the invention is applied to a multiple-row roller bearing 18. In other words, multiple rows of cylindrical shaped outer-ring raceways 9, 9 are formed around the inner peripheral surface of the cylindrical shaped outer race 19. Also, an inward-facing flange section 10b is formed all the way around the circumference in the middle of the inner peripheral surface of this outer race 19 in the section between both outer-ring raceways 9, 9. Moreover, flanged rings 4, 4 are located on both end surfaces in the axial direction of this outer race 19, and these flanged rings 4, 4 have a section that protrudes further inward in the radial direction than the outer-ring raceway 9, 9 to form the inward-facing flange sections 10a, 10a. Also, a pair of inner races 2, 2 are located on the inner diameter side of the outer race 19 such that their inside end surfaces in the axial direction come together. Cylindrical shaped inner-ring raceways 7, 7 are formed around the outer peripheral surface of these inner races 2, 2. Moreover, outward-facing flange sections 8a, 8a are formed all the way around the circumference on the ends in the axially opposite sides of each of the inner-ring raceways 7, 7. A plurality of rollers 5a, 5a are located between each of the outer-ring raceways 9, 9 and inner-ring raceways 7, 7, and held in cages 6, 6 such that they can rotate freely. In this condition, the end surfaces on the axially opposite ends of the rollers 5a, 5a face toward the side surfaces 11a, 11a of the outward-facing and inward-facing flange sections 8a, 10a, 10b.

Particularly, in the case of this example, the end surfaces on the axially opposite sides of the rollers 5a have contact sections that fit with the inner side surfaces 11a, 11a of the outward-facing and the inward-facing flange sections 8a, 10a, 10b of the inner races 2, 2, outer race 19 and flanged rings 4, 4, and the contact sections have tapered convex surfaces 22, 22 that are inclined such that the outer diameter increases in the direction toward the middle in the axial direction of the roller 5a. In addition, the line ‘X’ connecting with the center O of the roller 5 with the centers S, S of the generatrix of the contact section of the tapered convex surfaces 22, 22 on both ends of the roller 5a that comes in contact with the tapered convex or tapered concave surfaces of the outward-facing and inward-facing flange sections 8a, 10a, 10b coincides with the line normal to the generatrix of the centers S, S. On the other hand, the sections of the inner side surfaces 11a of the outward-facing and inward-facing flange sections 8a, 10a, 10b that fit with tapered convex surfaces 22, 22 of the rollers 5a are tapered convex surfaces or tapered concave surfaces having a generatrix with the same angle of inclination as the generatrix of the tapered convex surfaces 22, 22.

In the case of this example as well, the condition of contact between the end surfaces on the axially opposite ends of the rollers 5a and the corresponding side surfaces 11a, 11a of the outward-facing and inward-facing flange sections 8a, 10a, 10b can be taken to be linear contact and near to a condition of rolling contact. Therefore, even when rotating at high speed, it is possible to reduce damage such as slide marks, smearing, scraping and seizure, and even when impact loads, vibrating loads or repeated loads are applied, it is possible to easily maintain seizure resistance.

Also, the forces that are applied to the contact sections between the tapered convex surfaces 22, 22 of the rollers 5a and the tapered convex or tapered concave surfaces of the outward-facing and inward-facing flange sections 8a, 10a, 10b due to axial loads and radial loads act in the direction toward the center of the rollers 5a and cancel each other out. Therefore, it becomes difficult for forces to act that cause the rollers 5a to displace. As a result, it is possible to improve the axial load capability at the areas of contact (capability to support larger axial loads without damage such as scraping or seizure occurring at the areas of contact), and since the roller bearing does not need to be used in combination with other rolling bearings, it is possible to simplify and make the rotation support section more compact, and thus it is also possible to reduce cost by simplifying and making the roller bearing more compact.

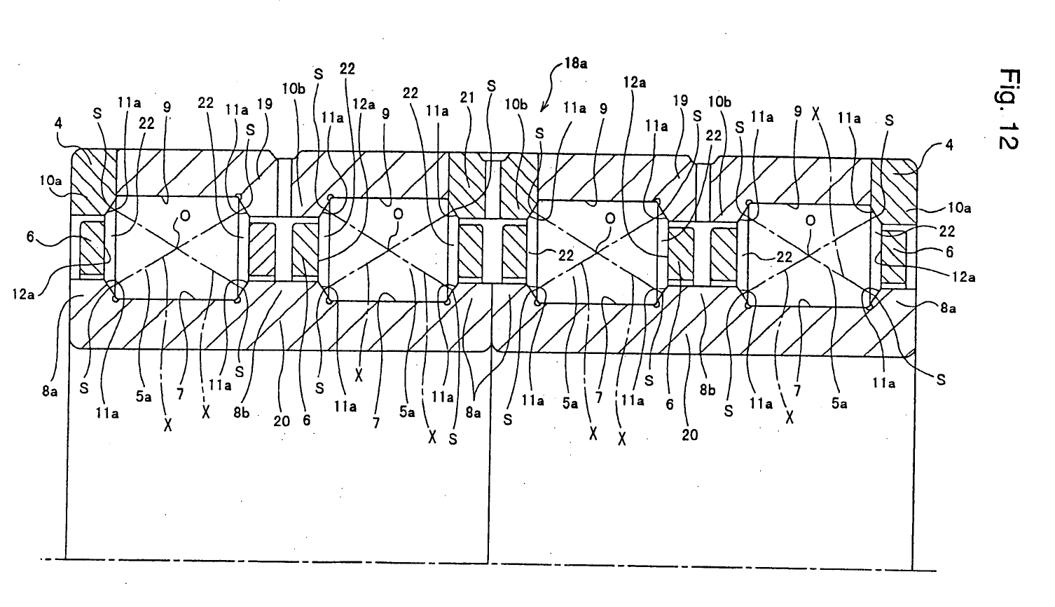

Next, FIG. 12 shows a ninth example of the embodiment of the invention. In the case of this example, the invention is applied to a multi-row (four row) roller bearing 18a. In other words, a plurality of rows of cylindrical shaped outer-ring raceways 9, 9 are formed around the inner peripheral surface of a pair of concentric cylindrical shaped outer races 19, 19. Inward-facing flange sections 10b, 10b are formed all the way around the circumference in the sections between both outer race raceways 9, 9 in the middle in the axial direction of the inner peripheral surface of these outer races 19, 19. Moreover, flanged rings 4, 21 are located in the sections between the axially outer ends and the axially inner ends of the outer races 19, 19, and the parts of these flanged rings 4, 21 that protrude further inward in the radial direction than the outer-ring raceways 9, 9 act as the inward-facing flange sections 10a, 10b. Also, a pair of inner races 20, 20 are located on the inner-diameter side of the outer races 19, 19 such that they are concentric and that the axially inner ends come together. A plurality of cylindrical shaped inner-ring raceways 7, 7 is formed around the outer peripheral surfaces of these inner races 20, 20. Outward-facing flange sections 8b, 8a are formed all the way around the circumference in the section between both inner-ring raceways 7, 7 in the middle in the axial direction of the outer peripheral surface of the inner races 20, 20, and on the axially opposite ends of the inner-ring raceways 7, 7. In addition, a plurality of rollers 5a, 5a are located between each of the outer-ring raceways 9, 9 and inner-ring raceways 7, 7, and rotatably held by cages 6, 6. In this condition, the end surfaces in the axial direction of the rollers 5a, 5a, face toward the side surfaces 11a, 11a of the outward-facing and inward-facing flange sections 8a, 8b, 10a, 10b.

In the case of this example, the axially opposite end surfaces of the rollers 5a have contact sections that fit with the side surfaces 11a, 11a of the outward-facing and inward-facing flange sections 8a, 8b, 10a, 10b, which are formed around the inner races 20, 20, outer race 19, 19 and flange rings 4, 21, and the contact sections have tapered convex surfaces 22, 22 that are inclined such that the outer diameter increases in the direction toward the middle in the axial direction of the roller 5a. In addition, the line ‘X’ connecting the center o of the roller 5a with the centers S, S of the generatrix of the sections of the tapered convex surfaces 22, 22 on both ends of the roller 5a that comes in contact with the tapered convex or tapered concave surfaces of the outward-facing and inward-facing flange sections 8a, 8b, 10a, 10b coincides with the line normal to the generatrix of the centers S, S. On the other hand, the contact sections of the side surfaces 11a, 11a of the outward-facing and inward-facing flange sections 8a, 8b, 10a, 10b that fit with tapered convex surfaces 22, 22 of the rollers 5 have tapered convex surfaces or tapered concave surfaces having a generatrix with the same angle of inclination as the generatrix of the tapered convex surfaces 22, 22. The other construction and function are substantially the same as those of the eighth example described above.

### Applicability to the Industry

The roller bearing of this invention is constructed and functions as described above, so the contact state of the contact sections where the side surface of the flanged portion comes into contact with the axial end surface of the rollers can be placed substantially in the rolling contact state, thereby improving anti-seizure property at the contact sections. With the improvement of anti-seizure property based on reduction in tilt-moment, the axial load capacity can be sufficiently improved at the contact sections. In addition, in the case where a cage is used, the durability (anti-damage strength) of the cage can be improved. As a result, this roller bearing can be widely used in all kinds of rotation support that are operated under severe conditions, making it possible to make the rotation support more compact while at the same time maintain durability of the rotation support.

1. A roller bearing comprising:
an inner race having an outer peripheral surface formed with a cylindrical inner-ring raceway therearound,
an outer race having an inner peripheral surface formed with a cylindrical outer-ring raceway therearound, and
a plurality of rollers rotatably located between the outer-ring raceway and the inner-ring raceway, and
a flange section formed on at least opposite ends in the axial direction of the ends in the axial direction of the outer-ring raceway and inner-ring raceway, such that axial loads are supported by the engagement between the side surfaces of the flange sections and the end surfaces in the axial direction of the rollers,
the outer peripheral surface of the rollers being formed in a cylindrical surface, such that the section near the outer diameter of the axial opposite end surfaces coming into contact with the side surface of the flange section is formed in a tapered convex shape that is inclined such that the outer diameter becomes larger toward the middle in the axial direction of the roller,
the side surface of the flange sections mating with the tapered convex shape, being formed in a tapered convex shape or tapered concave shape having a generatrix that is at the same angle of inclination as the generatrix of the tapered convex surface, wherein a generatrix defines the contact section at which the tapered convex surface of the ends of the rollers comes into contact with the side surface in the tapered convex or concave shape of the flange sections, and wherein any point on the generatrix is connected by a line with the center of the rollers, and wherein this line coincides with the line normal to the generatrix at the point.
